(19) United States
(12) Patent Application Publication
(10) Pub. No.: US 2009/0243706 A1
(43) Pub. Date: Oct. 1, 2009

(54) VOLTAGE REGULATED CHARGE PUMP

(76) Inventors: Ching-Wei Hsueh, Sinshih Township (TW); Ching-Yi Wu, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/059,125

(22) Filed: Mar. 31, 2008

(51) Int. Cl. G05F 1/10

(52) U.S. Cl. 327/536

(57) ABSTRACT

A voltage regulated charge pump includes a charge pump circuit for receiving an input voltage to generate an output voltage, in which the charge pump circuit further includes a capacitor, a first switch and a second switch. The first switch is coupled between the input voltage and a first end of the capacitor. The second switch is coupled to the first end of the capacitor. The first and second switch are non-simultaneously turned on, so that the capacitor is charged to generate the output voltage. The voltage regulated charge pump further includes a third switch and a voltage regulating circuit. The third switch is coupled to the charge pump circuit. The voltage regulating circuit has an input receiving the output voltage and an output coupled to the third switch. The voltage regulating circuit modulates the third switch for regulating the output voltage generated by the charge pump circuit.

### BACKGROUND

1. Field of Invention

The present invention relates to a charge pump. More particularly, the present invention relates to a voltage regulated negative charge pump.

2. Description of Related Art

A traditional charge pump, which makes use of the charge storing capability of capacitors, is provided to generate an output voltage that is the double or triple of a supply voltage. However, for a gate driver in a liquid crystal display (LCD), it is necessary to provide bias voltages, e.g. Vgh and Vgl, which are more precise to boost the gate driver for driving gate lines. Therefore, a charge pump with voltage regulation capabilities and the ability to generate a regulated output voltage is needed.

To this end, a voltage regulated charge pump, which takes advantage of an error amplifier to regulate the output voltage, is provided, so as to obtain more precise bias voltages to boost the gate driver. However, the liquid crystal display has become bigger, so the voltage regulated charge pump has to provide a higher output voltage for the loading of the large-sized liquid crystal display. In addition, the error amplifier of the conventional voltage regulated charge pump must be designed accordingly to have more sinking and sourcing capabilities to fit in with the large-sized liquid crystal display. Therefore, developing a voltage regulated charge pump for large-sized liquid crystal display is difficult, and the charge pump may have stability problems.

### SUMMARY

In accordance with one embodiment of the present invention, a voltage regulated charge pump is provided. The voltage regulated charge pump includes a charge pump circuit for receiving an input voltage to generate an output voltage, in which the charge pump circuit further includes a capacitor, a first switch and a second switch. The first switch is coupled between the input voltage and a first end of the capacitor. The second switch is coupled to the first end of the capacitor. The first and second switch are non-simultaneously turned on, so that the capacitor is charged to generate the output voltage. The voltage regulated charge pump further includes a third switch and a voltage regulating circuit. The third switch is coupled to the charge pump circuit. The voltage regulating circuit has an input receiving the output voltage and an output coupled to the third switch. The voltage regulating circuit is configured to modulate the third switch for regulating the output voltage generated by the charge pump circuit.

For the foregoing embodiment of the present invention, the voltage regulated charge pump can be provided to fit in with the large-sized liquid crystal display and output the required and more precise output voltage, so as to solve the stability problems caused when the voltage regulated charge pump outputs a large voltage.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 shows a voltage regulated charge pump according to one embodiment of the present invention.

### DESCRIPTION OF THE PREFERRED EMBODIMENTS

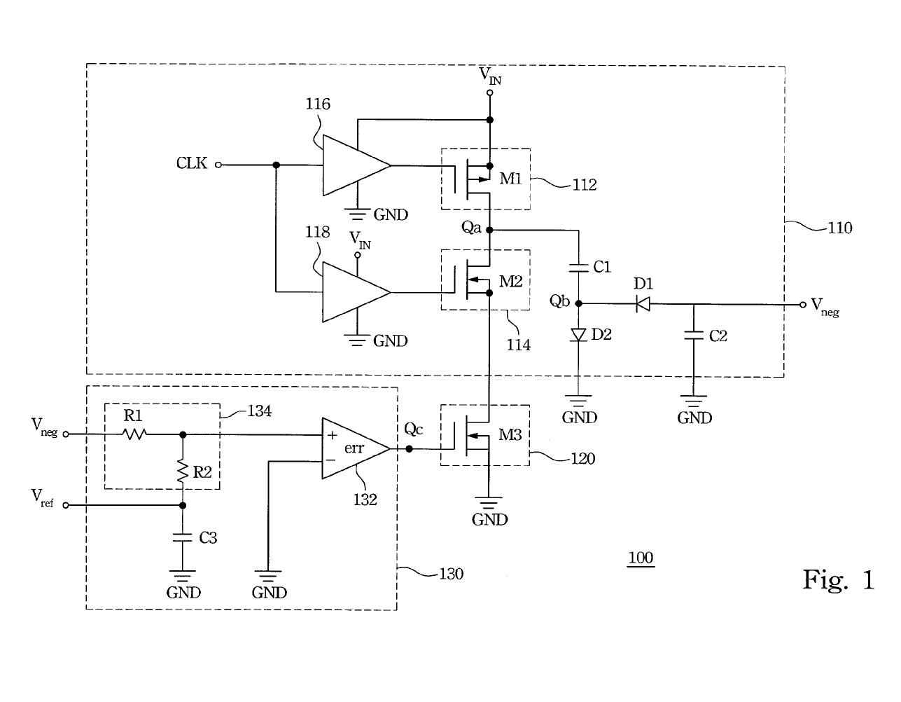

FIG. 1 shows a voltage regulated charge pump according to one embodiment of the present invention. The voltage regulated charge pump 100 is a negative charge pump and includes a charge pump circuit 110 for receiving an input voltage V_{IN} to generate an output voltage V_{neg}. The charge pump circuit 110 includes a capacitor C1, a first switch 112, a second switch 114, a first operational amplifier 116 and a second operational amplifier 118. The first switch 112 is coupled between the input voltage V_{IN} and a first end of the capacitor C1, and the second switch 114 is coupled to the first end of the capacitor C1. The first operational amplifier 116 is coupled to the input voltage V_{IN} and a ground GND, and receives a clock signal CLK to control the first switch 112. The second operational amplifier 118 is coupled to the input voltage V_{IN} and the ground GND, and receives the clock signal CLK to control the second switch 114. The first switch 112 and the second switch 114 are non-simultaneously turned on by the first operational amplifier 116 and the second operational amplifier 118 respectively according to the clock signal CLK, so that the capacitor C1 is charged to generate the output voltage V_{neg}.

The voltage regulated charge pump 100 further includes a third switch 120 and a voltage regulating circuit 130. The third switch 120 is coupled to the second switch 114. The voltage regulating circuit 130 has an input receiving the output voltage V_{neg} and an output coupled to the third switch 120. The voltage regulating circuit 130 is configured to modulate the third switch 120 for regulating the output voltage V_{neg} generated by the charge pump circuit 110. Moreover, the voltage regulating circuit 130 also receives a reference voltage V_{ref}, which is usually set at a level to compare fluctuations in the output voltage V_{neg}.

In the present embodiment, the first switch 112 is a p-type metal-oxide-semiconductor field effect transistor (MOSFET) M1, and the second switch 114 is an n-type MOSFET M2. The transistor M1 has a gate coupled to the output of the first operational amplifier 116, a source coupled to the input voltage V_{IN}, and a drain coupled to the first end of the capacitor C1. The transistor M2 has a gate coupled to the output of the second operational amplifier 118, a drain coupled to the first end of the capacitor C1, and a source coupled to the third switch 120. In addition, the third switch 120 can be an n-type MOSFET M3, in which the transistor M3 has a drain coupled to the source of the transistor M2, a source coupled to the ground GND, and a gate coupled to the voltage regulating circuit 130.

The voltage regulating circuit 130 further includes an error amplifier 132 and a voltage dividing circuit 134, in which the error amplifier 132 is an operational amplifier and configured to modulate the transistor M3. The error amplifier 132 has a first amplifier input coupled to the voltage dividing circuit 134, a second amplifier input coupled to the ground GND, and an amplifier output coupled to the gate of the transistor M3 so as to control the turn-on state of the transistor M3. The voltage dividing circuit 134 is coupled between the output voltage V_{neg} and the first amplifier input of the error amplifier 132, and outputs a fraction of the output voltage V_{neg} to the first amplifier input of the error amplifier 132. Furthermore, the voltage dividing circuit 134 can include two resistors R1 and R2, in which the resistor R1 has an end connected to the output voltage V_{neg} and another end connected to the first amplifier input of the error amplifier 132, and the resistor R2 has an end connected to the first amplifier input of the error amplifier 132 and another end connected to the reference voltage V_{ref}.

One embodiment of the operation of the voltage regulated charge pump 100 is described as follows. The charge pump circuit 110 is operated during different periods to generate the regulated output voltage V_{neg} according to the clock signal CLK. During the first period, the transistor M1 is turned on and the transistor M2 is turned off, the voltage of the node Qa is thus charged approximately to the input voltage V_{IN}, and the voltage of the node Qb is at a very low level and close to 0. At that moment, the output voltage V_{neg} is generated by the capacitor C1 and output to the first amplifier input of the error amplifier 132 through the resistor R1. The error amplifier 132 receives the fraction of the output voltage V_{neg} to output an error signal to turn on the transistor M3. If the output voltage V_{neg} changes based on the capacitor C1, the voltage of the amplifier output of the error amplifier 132, i.e. the voltage of the node Qc, will vary accordingly and thus changes the turn-on state of the s transistor M3. Since the turn-on state of the transistor M3 is changed, a turn-on resistance Rds(on) that is related to the turn-on state of the transistor M3 changes accordingly. Therefore, the turn-on resistance Rds(on) of the transistor M3 is modulated according to the error amplifier 132.

After that, during the second period, since the transistor M1 is turned off and the transistor M2 is turned on, a different output voltage V_{neg} is thus generated by the capacitor C1 and output to the first amplifier input of the error amplifier 132 through the resistor R1. At that moment, the transistor M3 remains turned on, so the current flowing through the transistor M3 is continuous. Since the current flowing through the transistor M3 is continuous, there are fewer ripples appeared in the output voltage V_{neg}. The output voltage V_{neg} can be regulated only by modulating the turn-on resistance Rds(on) of the transistor M3. In other words, the charge pump can thus provide the regulated output voltage V_{neg} only by controlling the turn-on state of the transistor M3, without considering the sinking and sourcing capabilities of the error amplifier 132.

Therefore, the output voltage V_{neg} of the charge pump can be regulated only by controlling the turn-on state of the transistor M3; that is, the charge pump can provide the regulated output voltage V_{neg} only by modulating the turn-on resistance Rds(on) of the transistor M3, even if the charge pump has to provide a higher output voltage for a large-sized liquid crystal display. The charge pump can be thus operated stably as well.

For the foregoing embodiment of the present invention, the voltage regulated charge pump can be provided to fit in with the large-sized liquid crystal display and output the required and more precise output voltage, so as to solve the stability problems caused when the voltage regulated charge pump outputs the large voltage.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A voltage regulated charge pump, comprising:
a charge pump circuit for receiving an input voltage to generate an output voltage, the charge pump circuit further comprising:
a capacitor;
a first switch coupled between the input voltage and a first end of the capacitor; and
a second switch coupled to the first end of the capacitor, wherein the first and second switch are non-simultaneously turned on, so that the capacitor is charged to generate the output voltage;
a third switch coupled to the charge pump circuit; and
a voltage regulating circuit having an input receiving the output voltage and an output coupled to the third switch;
wherein the voltage regulating circuit is configured to modulate the third switch for regulating the output voltage generated by the charge pump circuit.

2. The voltage regulated charge pump as claimed in claim 1, wherein the voltage regulating circuit further comprises:
an error amplifier having a first amplifier input coupled to the output voltage, a second amplifier input coupled to a ground, and an amplifier output configured to modulate the third switch.

3. The voltage regulated charge pump as claimed in claim 2, wherein the voltage regulating circuit further comprises:
a voltage dividing circuit coupled between the output voltage and the first amplifier input of the error amplifier and outputting a fraction of the output voltage to the first amplifier input.

4. The voltage regulated charge pump as claimed in claim 3, wherein the voltage dividing circuit further comprises:
a first resistor having a first end connected to the output voltage and a second end connected to the first amplifier input of the error amplifier; and
a second resistor having a third end connected to the first amplifier input of the error amplifier and a fourth end connected to a reference voltage.

5. The voltage regulated charge pump as claimed in claim 2, wherein the third switch is an n-type metal-oxide-semiconductor field effect transistor.

6. The voltage regulated charge pump as claimed in claim 5, wherein the transistor has a gate coupled to the amplifier output of the error amplifier, a drain coupled to the second switch, and a source coupled to the ground.

7. The voltage regulated charge pump as claimed in claim 5, wherein a turn-on resistance of the transistor is modulated according to the error amplifier.

8. The voltage regulated charge pump as claimed in claim 2, wherein the error amplifier is an operational amplifier.

9. The voltage regulated charge pump as claimed in claim 1, wherein the first and second switch are separately turned on according to a clock signal.

10. The voltage regulated charge pump as claimed in claim 9, wherein the charge pump circuit further comprises:
a first operational amplifier coupled to the input voltage and receiving the clock signal to control the first switch; and
a second operational amplifier coupled to the input voltage and receiving the clock signal to control the second switch.

11. The voltage regulated charge pump as claimed in claim 1, wherein the first and second switch are a p-type and n-type metal-oxide-semiconductor field effect transistor, respectively.

12. The voltage regulated charge pump as claimed in claim 1, wherein the voltage regulated charge pump is a negative charge pump.
